(19) United States
(12) Patent Application Publication
(10) Pub. No.: US 2023/0058756 A1
(43) Pub. Date: Feb. 23, 2023

(54) SACCHARIDE-REDUCED FRUIT BEVERAGE AND METHOD FOR PRODUCING THE SAME

(71) Applicant: KIRIN HOLDINGS KABUSHIKI KAISHA, Nakano-ku, Tokyo (JP)

(72) Inventors: Akira HORIE, Nakano-ku, Tokyo (JP); Chiaki NISHIYAMA, Nakano-ku, Tokyo (JP); Hideyuki WAKABAYASHI, Nakano-ku, Tokyo (JP)

(73) Assignee: KIRIN HOLDINGS KABUSHIKI KAISHA, Nakano-ku, Tokyo (JP)

(21) Appl. No.: 17/789,092

(22) PCT Filed: Dec. 18, 2020
(86) PCT No.: PCT/JP2020/047442

§ 371 Date: Jun. 24, 2022

(30) Foreign Application Priority Data
Dec. 27, 2019 (JP) 2019-239788

(51) Int. Cl. A23L 2/02; A23L 2/84; A23L 2/56; A23L 27/20

(52) U.S. Cl. CPC A23L 2/02; A23L 2/84; A23L 2/56; A23L 27/203; A23L 27/2028; A23V 2002/00

(57) ABSTRACT

An object is to provide a novel saccharide-reduced fruit beverage having an improved flavor. According to the present invention, provided is a fruit beverage containing citrus fruit and having a sucrose concentration of 1.4 g/100 mL or less in terms of Brix 11°, in which the beverage has an ethyl ester concentration of 25 to 50 ppb and/or a monoterpene derivative concentration of 600 to 3,000 ppb. The citrus fruit in the present invention can be selected from the group consisting of oranges, grapefruit, and Unshu mikan, and a proportion of a fruit juice in the beverage can be set to 30% or more.

### CROSS-REFERENCE TO RELATED APPLICATION

The present application enjoys the benefit of priority from the prior Japanese Patent Application No. 2019-239788 filed on Dec. 27, 2019, the entire disclosure of which is incorporated herein by reference and considered as a part of the present specification.

### TECHNICAL FIELD

The present invention relates to a saccharide-reduced fruit beverage and a method for producing the same. The present invention also relates to a method for improving a flavor of the saccharide-reduced fruit beverage.

### BACKGROUND ART

With the rise of health consciousness in recent years, it has become desirable for the carbohydrate intake when ingesting foods and drinks to be reduced, and it is also said that reduction in carbohydrate intake will be a social issue in the future. Fruit beverages are widely popular among consumers for maintaining their health because consumers can easily consume fruit thereby. However, since these beverages contain carbohydrates derived from fruit, it can be stated that the content of carbohydrates would desirably be reduced as much as possible from the viewpoint of reducing the carbohydrate intake.

Regarding fruit beverages, techniques for removing monosaccharides or disaccharides from a fruit juice by subjecting the fruit juice to a membrane treatment to reduce calories (Patent Documents 1 and 2) or a technique for treating a fruit juice with fructosyltransferase crude enzyme agent to reduce calories (Patent Document 3) have been proposed.

### REFERENCE LIST

### Patent Documents

Patent Document 1: Japanese Translation of PCT Application No. 2010-520743
Patent Document 2: WO 2006/004106
Patent Document 3: WO 2016/092768

### SUMMARY OF THE INVENTION

The present inventors have found that fruit juices with a reduced amount of saccharides tend to lack in voluminous feeling compared to ordinary fruit juices and that the insufficient voluminous feeling due to a low content of saccharides can be improved by adjusting to a predetermined concentration of ethyl esters and/or monoterpene derivatives in the fruit juices with a reduced amount of saccharides. The present invention is based on these findings.

An object of the present invention is to provide a novel saccharide-reduced fruit beverage with an improved flavor and a method for producing the same. Another object of the present invention is to provide a method for improving a flavor of a saccharide-reduced fruit beverage. Still another object of the present invention is to provide a method for improving an insufficient voluminous feeling of a saccharide-reduced fruit beverage.

According to the present invention, the following aspects are provided. [1] A fruit beverage containing citrus fruit and having a sucrose concentration of 1.4 g/100 mL or less in terms of Brix 11°, in which the beverage has an ethyl ester concentration of 25 to 50 ppb and/or a monoterpene derivative concentration of 600 to 3,000 ppb.

[2] A fruit beverage containing a saccharide-reduced citrus fruit juice, in which the beverage has an ethyl ester concentration of 25 to 50 ppb and/or a monoterpene derivative concentration of 600 to 3,000 ppb.

[3] The fruit beverage according to [1] or [2] described above, in which the ethyl esters include one or more selected from the group consisting of ethyl hexanoate, ethyl 3-hydroxyhexanoate, ethyl butyrate, ethyl 2-methylbutyrate, ethyl propionate, ethyl 2-methylpropionate, ethyl acetate, and ethyl tiglate.

[4] The fruit beverage according to any one of [1] to [3] described above, in which the monoterpene derivatives include one or more selected from the group consisting of α-terpineol, terpinyl acetate, limonene, γ-terpinene, α-phellandrene, α-pinene, β-pinene, linalool, myrcene, geraniol, and citral.

[5] The fruit beverage according to any one of [1] to [4] described above, in which the citrus fruit includes one or more selected from the group consisting of oranges, grapefruit, and Unshu mikan.

[6] The fruit beverage according to any one of [1] to [5] described above, in which a proportion of the fruit juice in the beverage is 30% or more.

[7] A method for producing a fruit beverage containing citrus fruit and having a sucrose concentration of 1.4 g/100 mL or less in terms of Brix 11°, the method including: adjusting an ethyl ester concentration in the beverage to 25 to 50 ppb; and/or adjusting a monoterpene derivative concentration in the beverage to 600 to 3,000 ppb.

[8] The production method according to [7] described above, further including: a step of reducing an amount of saccharides of the beverage.

[9] The production method according to [8] described above, in which the step of reducing an amount of saccharides is performed by one or more treatments selected from the group consisting of enzymatic treatment, a membrane filtration treatment, a catalyst treatment, and a fermentation treatment.

[10] The production method according to any one of [7] to [9] described above, in which the citrus fruit includes one or more selected from the group consisting of oranges, grapefruit, and Unshu mikan.

[11] A method for improving a flavor of a fruit beverage containing citrus fruit and having a sucrose concentration of 1.4 g/100 mL or less in terms of Brix 11° and a method for improving an insufficient voluminous feeling of the fruit beverage, the methods including: adjusting an ethyl ester concentration in the beverage to 25 to 50 ppb; and/or adjusting a monoterpene derivative concentration in the beverage to 600 to 3,000 ppb.

The beverages of [1] and [2] described above are sometimes referred to as “beverages of the present invention” in the present specification.

According to the present invention, it is possible to improve a flavor of the saccharide-reduced fruit beverage which tends to decrease. That is, the present invention is advantageous in that a saccharide-reduced fruit beverage which has a flavor comparable to that of ordinary fruit juices and is low-calorie can be provided.

### DETAILED DESCRIPTION OF THE INVENTION

### <<Beverages of Present Invention>>

A “fruit beverage” in the present invention means a beverage using a fruit juice as a raw material. Examples thereof include fruit juice, fruit mixed juice, fruit granule-containing fruit juice, concentrated fruit juice, and a fruit juice-containing beverage. The beverages of the present invention can be non-alcoholic beverages containing no alcohol.

Examples of “fruit” in the present invention include citrus fruit such as oranges, grapefruit, and Unshu mikan, and pineapples, apples, grapes, peaches, strawberries, bananas, mangoes, melons, and apricots. Oranges, grapefruit, and Unshu mikan can be preferably used.

A “Brix value” (sometimes simply referred to as “Brix” in the present specification) in the present invention is an index indicating a total concentration of soluble solid contents (for example, saccharides, proteins, and peptides) contained in a solution and is a value obtained by converting a refractive index of the solution measured at 20° C. into mass/mass % of a pure sucrose solution using the conversion table of the International Commission for Uniform Methods of Saccharide Analysis (ICUMSA). The refractive index at 20° C. can be measured using a commercially available saccharide refractometer such as a saccharimeter manufactured by Atago Co., Ltd.

“Brix A° conversion” in the present invention means a quantitative value of a beverage obtained by adjusting a Brix value of the beverage to A°. For example, a “fruit beverage having a sucrose concentration of 1.4 g/100 mL or less in terms of Brix 11°” means a fruit beverage having a sucrose concentration of 1.4 g/100 mL or less when a Brix value is adjusted to 11° through dilution or concentration.

“Reduction in the amount of saccharides” in the present invention means that the amount of saccharides is reduced compared to those of fruit or fruit juices as raw materials. The reduction in the amount of saccharides can be achieved through treatments of processing a raw material fruit juice, that is, enzymatic treatment, a membrane filtration treatment, a catalyst treatment, a fermentation treatment, and the like, as will be described below.

“Saccharides” in the present invention means carbohydrates such as monosaccharides and disaccharides. Examples thereof include glucose, fructose, galactose, sucrose, and maltose. The saccharide concentration can be measured through high-performance liquid chromatography (HPLC method).

The beverages of the present invention are saccharide-reduced fruit beverages having a saccharide concentration or a sucrose concentration of a predetermined value or less in terms of a Brix value.

The beverages of the present invention can be set to have a sucrose concentration of 1.4 g/100 mL or less (for example, 0.1 to 1.4 g/100 mL), preferably 0.8 g/100 mL or less (for example, 0.3 to 0.8 g/100 mL), and more preferably 0.6 g/100 mL or less (for example, 0.3 to 0.6 g/100 mL) in terms of Brix 11°. The beverages of the present invention can be set to have a saccharide concentration of 6.0 g/100 mL or less (for example, 4.5 to 6.0 g/100 mL) and preferably 5.5 g/100 mL or less (for example, 5.0 to 5.5 g/100 mL) in terms of Brix 11°.

An orange fruit juice beverage (orange juice) among the beverages of the present invention can be set to have a sucrose concentration of 1.4 g/100 mL or less (for example, 0.1 to 1.4 g/100 mL), preferably 0.8 g/100 mL or less (for example, 0.3 to 0.8 g/100 mL), and more preferably 0.6 g/100 mL or less (for example, 0.3 to 0.6 g/100 mL) in terms of Brix 11°. In addition, the orange fruit juice beverage among the beverages of the present invention can be set to have a saccharide concentration of 6.0 g/100 mL or less (for example, 4.5 to 6.0 g/100 mL) and preferably 5.5 g/100 mL or less (for example, 5.0 to 5.5 g/100 mL) in terms of Brix 11°.

A grapefruit fruit juice beverage (grapefruit juice) among the beverages of the present invention can be set to have a sucrose concentration of 1.1 g/100 mL or less (for example, 0.3 to 1.1 g/100 mL) and preferably 0.9 g/100 mL or less (for example, 0.5 to 0.9 g/100 mL) in terms of Brix 9°. In addition, the grapefruit fruit juice beverage among the beverages of the present invention can be set to have a saccharide concentration of 7.4 g/100 mL or less (for example, 6.5 to 7.4 g/100 mL) and preferably 7.3 g/100 mL or less (for example, 6.8 to 7.3 g/100 mL) in terms of Brix 9°.

An Unshu mikan fruit juice beverage (Unshu mikan juice) among the beverages of the present invention can be set to have a sucrose concentration of 1.2 g/100 mL or less (for example, 0.3 to 1.2 g/100 mL) and preferably 0.7 g/100 mL or less (for example, 0.5 to 0.7 g/100 mL) in terms of Brix 9°. In addition, the Unshu mikan fruit juice beverage among the beverages of the present invention can be set to have a saccharide concentration of 7.8 g/100 mL or less (for example, 6.5 to 7.8 g/100 mL) and preferably 7.6 g/100 mL or less (for example, 7.0 to 7.6 g/100 mL) in terms of Brix 9°.

The beverages of the present invention contain either or both of ethyl esters and monoterpene derivatives at predetermined concentrations. The concentrations of the ethyl esters and the monoterpene derivatives in the beverages of the present invention do not depend on the Brix values of the beverages of the present invention and are numerical values within determined concentration ranges. In addition, in the present invention, the ethyl esters and the monoterpene derivatives are sometimes referred to as aroma components.

The ethyl esters contained in the beverages of the present invention may be any as long as these improve a flavor of saccharide-reduced fruit beverages and are acceptable as foods. Examples thereof include ethyl hexanoate, ethyl 3-hydroxyhexanoate, ethyl butyrate, ethyl 2-methylbutyrate, ethyl propionate, ethyl 2-methylpropionate, ethyl acetate, and ethyl tiglate, and preferred examples thereof include ethyl hexanoate and ethyl butyrate. One or more of these can be used in the present invention.

The lower limit value of the ethyl ester concentrations in the beverages of the present invention can be set to 25 ppb, 28 ppb, or 30 ppb, and the upper limit value thereof can be set to 50 ppb, 45 ppb, or 40 ppb. These lower limit values and upper limit values can be arbitrarily combined, and the range of the above-described concentrations can be set to 25 to 50 ppb, and preferably set to 28 to 45 ppb or 30 to 40 ppb.

The ethyl ester concentration in the beverages of the present invention may be a total value of each of concentrations of ethyl hexanoate, ethyl 3-hydroxyhexanoate, ethyl butyrate, ethyl 2-methylbutyrate, ethyl propionate, ethyl 2-methylpropionate, ethyl acetate, and ethyl tiglate, and preferably a total value of each of concentrations of ethyl hexanoate and ethyl butyrate. The ethyl ester concentration in the beverages of the present invention may also be a concentration of ethyl hexanoate, ethyl butyrate, or ethyl acetate.

Monoterpene derivatives contained in the beverages of the present invention may be any as long as these improve a flavor of saccharide-reduced fruit beverages and are acceptable as foods. Examples thereof include α-terpineol, terpinyl acetate, limonene, γ-terpinene, α-phellandrene, α-pinene, β-pinene, linalool, myrcene, geraniol, and citral, and preferred examples thereof include linalool, α-terpineol, citral, and geraniol. One or more of these can be used in the present invention.

The lower limit value of the monoterpene derivative concentrations in the beverages of the present invention can be set to 600 ppb, 750 ppb, or 900 ppb, and the upper limit value thereof can be set to 3,000 ppb, 2,500 ppb, or 2,000 ppb. These lower limit values and upper limit values can be arbitrarily combined, and the range of the above-described concentrations can be set to 600 to 3,000 ppb, and preferably set to 750 to 2,500 ppb or 1,000 to 2,000 ppb.

The monoterpene derivative concentrations in the beverages of the present invention may be a total value of each of concentrations of α-terpineol, terpinyl acetate, limonene, γ-terpinene, α-phellandrene, α-pinene, β-pinene, linalool, myrcene, geraniol, and citral, and preferably a total value of each of concentrations of linalool, α-terpineol, citral, and geraniol. The monoterpene derivative concentrations in the beverages of the present invention may also be a concentration of α-terpineol or citral.

In a case where the beverages of the present invention contain ethyl esters and monoterpene derivatives at predetermined concentrations, the lower limit value of the ratio of the content (ppb) of the monoterpene derivatives to the content (ppb) of the ethyl esters can be set to 10, 12, 25, or 50, and the upper limit value thereof can be set to 150, 120, or 100. These lower limit values and upper limit values can be arbitrarily combined, and the range of the above-described ratios can be set to, for example, 10 to 150 (preferably 12 to 120 or 50 to 100).

According to a preferred aspect of the present invention, there is provided a fruit beverage into which ethyl esters and/or monoterpene derivatives are incorporated. In a case where ethyl esters to be incorporated are one or more specific components, the ethyl ester concentration in each beverage of the present invention may be a total value of each of concentrations of the specific components (in a case of one specific component, the concentration of the component). For example, in a case where a beverage of the present invention is obtained by incorporating components containing ethyl hexanoate and ethyl butyrate as ethyl esters, the ethyl ester concentration in the beverage of the present invention may be a total value of each of concentrations of ethyl hexanoate and ethyl butyrate. In addition, in a case where monoterpene derivatives to be incorporated are one or more specific components, the monoterpene derivative concentration in each beverage of the present invention may be a total value of each of concentrations of the specific components (in a case of one specific component, the concentration of the component). For example, in a case where a beverage of the present invention is obtained by incorporating components containing linalool, α-terpineol, citral, and geraniol as monoterpene derivatives, the monoterpene derivatives concentration in the beverage of the present invention may be a total value of each of concentrations of linalool, α-terpineol, citral, and geraniol.

The concentrations of ethyl esters and monoterpene derivatives in a beverage can be measured through gas chromatography-mass spectrometry (GC/MS).

The beverages of the present invention may contain oligosaccharides. “Oligosaccharides” in the present invention are oligosaccharides having a polymerization degree of 3 to 10, and include lactosucrose, galactooligosaccharides, and fructooligosaccharides such as 1-kestose, nystose, neokestose, and fructofuranosylnystose and preferably include fructooligosaccharides. The beverages of the present invention can be specified as ones containing oligosaccharides at a predetermined concentration. The oligosaccharide concentration in a beverage can be measured through high-performance liquid chromatography (HPLC method).

The oligosaccharide concentration in the beverages of the present invention can be set to 0.1 g/100 mL or more in terms of Brix 11° or 0.09 g/100 mL or more in terms of Brix 9°.

The oligosaccharide concentration in the beverages of the present invention can also be determined for each type of fruit juice. For example, the orange fruit juice beverage among the beverages of the present invention can be set to contain oligosaccharides at 0.7 g/100 mL or more (for example, 0.7 to 2.0 g/100 mL) and preferably at 0.9 g/100 mL or more (for example, 0.9 to 1.5 g/100 mL) in terms of Brix 11°.

The grapefruit fruit juice beverage among the beverages of the present invention can be set to contain oligosaccharides at 0.1 g/100 mL or more (for example, 0.1 to 1.0 g/100 mL) and preferably at 0.2 g/100 mL or more (for example, 0.2 to 0.5 g/100 mL) in terms of Brix 9°.

The Unshu mikan fruit juice beverage among the beverages of the present invention can be set to contain oligosaccharides at 0.6 g/100 mL or more (for example, 0.6 to 2.5 g/100 mL) and preferably at 0.9 g/100 mL or more (for example, 0.9 to 1.2 g/100 mL) in terms of Brix 9°.

Fructooligosaccharides which are oligosaccharides contained in the beverages of the present invention are products obtained by in situ converting of sucrose contained in the fruit juice to fructooligosaccharides through enzymatic treatment in one aspect of the present invention. That is, the production of fructooligosaccharides in the beverages can be achieved through enzymatic treatment in a step of processing a raw material fruit juice or during or after a step of mixing a raw material fruit juice with other raw materials, as will be described below. Accordingly, the beverages of the present invention can be made so as not to contain fructooligosaccharides added as a raw material.

Beverage additives used for formulating and designing ordinary beverages may be incorporated into the beverages of the present invention. Examples of such additives include sweeteners (including high-intensity sweeteners), acidifiers, seasonings, spices, flavoring agents, colorants, thickeners, stabilizers, emulsifiers, nutrition enhancers, pH adjusters, antioxidants, and preservatives. The above-described beverage additives can be mixed with other raw materials in the mixing step to be described below.

The beverages of the present invention have a predetermined ethyl ester concentration and/or monoterpene derivative concentration as described above. Concentrated beverages and diluted beverages are within the scope of the present invention as long as they have these concentrations. That is, the beverages of the present invention also include so-called concentrated beverages thicker than 100% fruit juice and so-called diluted beverages thinner than 100% fruit juice.

The Brix values of the beverages of the present invention can be determined based on about 100% of fruit juice and can be set to 6 to 15° Bx (preferably 7 to 13° Bx). The Brix values of the beverages of the present invention can also be determined for each type of fruit juice. For example, the Brix value of the orange fruit juice beverage among the beverages of the present invention can be set to, for example, 8 to 15° Bx and preferably 9 to 13° Bx. The Brix value of the grapefruit fruit juice beverage among the beverages of the present invention can be set to, for example, 6 to 13° Bx and preferably 7 to 11° Bx. The Brix value of the Unshu mikan fruit juice beverage among the beverages of the present invention can be set to, for example, 6 to 13° Bx and preferably 7 to 11° Bx.

The proportion of the fruit juice in each beverage of the present invention is not particularly limited. However, the lower limit value (a value of not less than or greater than) thereof can be set to 30%, 35%, 40%, 50%, 60%, or 70%, and the upper limit value (a value of not more than or less than) thereof can be set to 150%, 120%, or 100%. These lower limit values and upper limit values can be arbitrarily combined, and the range of the above-described ratios can be set to, for example, 30 to 150% (preferably 40 to 120% or 50 to 100%). Here, the proportion of a fruit juice refers to a proportion of a fruit juice extract (also generally referred to as 100% juice, straight fruit juice, and 100% fruit juice) in an entire beverage. According to the JAS standards (the Japanese Agricultural Standards for fruit beverages), standards (° Bx) of saccharide refractometer readings for a fruit juice extract are determined for each fruit as shown in Table 1. The proportion of a fruit juice in a beverage can be calculated based on the standards. For example, the Brix value of 100% orange fruit juice is 11° Bx according to the JAS standards. When 10 mass % of concentrated orange fruit juice at 44° Bx is incorporated into a beverage, the proportion of the fruit juice in the beverage is 40%. In calculating the proportion of a fruit juice, when saccharides are added to a fruit juice extract, saccharide refractometer readings for sugars, honey, and the like that have been added may be excluded.

TABLE 1
Standards (°Bx) of saccharide refractometer readings

| | Standards (°Bx) of saccharide |
|---|---|
| Name of fruit | refractometer readings |
| Orange | 11 |
| Unshu mikan | 9 |
| Grapefruit | 9 |
| Natsumikan | 9 |
| Hassaku | 10 |
| Iyokan | 10 |
| Ponkan | 11 |
| Shiikuwasha | 8 |

[symbol]

In a case of fruits other than the fruits in this table, an average saccharide refractometer reading for the corresponding fruit juice extract is used as a standard of a saccharide refractometer reading.

The amount of saccharides in the beverages of the present invention can be reduced, and a voluminous feeling that tends to be insufficient due to the reduction in the amount of saccharides can be improved. That is, according to the present invention, it is possible to prevent deterioration in flavor of a saccharide-reduced fruit beverage due to the reduction in the amount of saccharides. Here, the “voluminous feeling” means spread of the entire flavor into the oral cavity from the middle to the latter half of drinking.

### <<Method for Producing Beverages of Present Invention>>

The saccharide-reduced fruit beverage of the present invention in which the concentration of saccharides such as sucrose is reduced can be produced by adjusting an ethyl ester concentration in the beverage to 25 to 50 ppb and/or adjusting a monoterpene derivative concentration in the beverage to 600 to 3,000 ppb.

The production method of the present invention may further comprise a step (saccharide reduction step) of reducing the amount of saccharides of the fruit beverage. The reduction of the concentration of saccharides (reduction in the amount of saccharides) can be performed by one or more treatments selected from the group consisting of enzymatic treatment, a membrane filtration treatment, a catalyst treatment, and a fermentation treatment. The saccharide reduction step can be carried out in a step of processing a raw material fruit juice or during or after a step of mixing a raw material fruit juice with other raw materials.

Examples of enzymes used for enzymatic treatment in the present invention include a glycosyltransferase using sucrose as a substrate. Examples of glycosyltransferases which are used in the production method of the present invention and uses sucrose as a substrate include fructosyltransferase, levansucrase, dextransucrases, and inulosucrases. One or more of these can be used, and fructosyltransferase is preferable.

Fructosyltransferase used in the production method of the present invention is an enzyme having an activity of producing fructooligosaccharides from sucrose. Commercially available fructosyltransferase can be used in the present invention. In the present invention, fructosyltransferase may be obtained by culturing microorganisms that produce fructosyltransferase and purifying and crudely purifying the enzyme from the cultured product.

Fructosyltransferase having substantially no pectinase activity can be used in the present invention. Here, “having substantially no pectinase activity” means that the enzyme has no activity of causing a remarkable clarification effect and/or viscosity reduction effect when treating a fruit juice. For example, when an enzymatic treatment test in which orange fruit juice is used is performed, an enzyme is taken as having substantially no pectinase activity in a case where fructooligosaccharides with a saccharide composition ratio of 10% or more are produced and the turbidity after the treatment is maintained at 35% or more as compared with that before the treatment.

In the production method of the present invention, in a case where fructosyltransferase having substantially no pectinase activity is used for enzymatic treatment, the turbidity and/or viscosity of a beverage produced are kept high. The ratio of the turbidity of a fruit juice after enzymatic treatment to the turbidity thereof before the enzymatic treatment, that is, the turbidity maintenance rate, can be set to 35% or more, preferably to 50% or more, and particularly preferably to 70% or more.

Fructosyltransferase in the form of a crude enzyme agent can be used in the present invention. Here, the “crude enzyme agent” means a relatively inexpensive and safe reagent or an enzyme agent obtained by separation and extraction means such as filtration membrane separation which is usually used as an enzyme agent sold for industrial production of foods, and does not include an enzyme agent prepared using advanced and high-cost separation and purification means such as fractional purification through liquid chromatography or the like.

In enzymatic treatment using fructosyltransferase in the present invention, 1 U or more of the fructosyltransferase per gram of sucrose in a fruit juice can be added as a guide, and 5 U per gram of sucrose is preferable and 10 U per gram of sucrose is particularly preferable. After adding the enzyme, the mixture is reacted at 25° C. for 4 hours as a guide. The temperature and the time can be appropriately adjusted according to the type of fruit juice or the amount of enzyme added. Note that a reaction at a high temperature for a long period of time causes decomposition of saccharides. In a case of using two or more fruit juices such as mixed juice, either method, that is, a method of mixing fruit juices after respectively subjecting the fruit juices to enzymatic treatment or a method of mixing fruit juices to collectively subject the fruit juices to enzymatic treatment, can be used. In a case of treating concentrated fruit juice, the treatment may be performed at any timing, that is, before, during, or after concentration.

In the present invention, membrane filtration treatment can be carried out on raw material fruit juices. Examples of filtration membranes that can be used include a nanofiltration membrane, a dialysis membrane, an ultrafiltration membrane, and a reverse osmosis membrane, and a nanofiltration membrane is preferable. As the filtration membrane used in the present invention, a membrane of which the transmittance of carbohydrates such as trisaccharides or higher saccharides is lower than that of monosaccharides or disaccharides can be selected. A membrane of which the transmittance of carbohydrates such as trisaccharides or higher saccharides is lower than that of monosaccharides and disaccharides and the difference in transmittance is 10% or more can be preferably selected, and a membrane having a fractional molecular weight of about 100 to 1,000 Da can be more preferably selected.

In the present invention, the amount of saccharides may be reduced by carrying out either enzymatic treatment or membrane filtration treatment alone or in combination of these treatments. In a case where the enzymatic treatment and the membrane filtration treatment are carried out in combination, the membrane filtration treatment can be carried out on a fruit juice before or after being subjected to the enzymatic treatment using an enzyme or may be carried out simultaneously to the enzymatic treatment using an enzyme.

The beverage of the present invention can be produced by adjusting an ethyl ester concentration in the beverage to within a range of 25 to 50 ppb and/or adjusting a monoterpene derivative concentration in the beverage to 600 to 3,000 ppb. In the production method of the present invention, the adjustment of the ethyl ester concentration and the adjustment of the monoterpene derivative concentration may be carried out individually, simultaneously, or at different timings in any order. In the production method of the present invention, adjustment of the concentration of aroma components can be carried out on a fruit juice before or after being subjected to a saccharide reduction treatment, or may be carried out simultaneously to a saccharide reduction treatment.

Ethyl esters used in the production method of the present invention may be used alone or in combination of plural kinds thereof, and pure ethyl ester products or commercially available flavoring agents containing ethyl esters may be used.

Monoterpene derivatives used in the production method of the present invention may be used alone or in combination of plural kinds thereof, and pure monoterpene derivative products or commercially available flavoring agents containing monoterpene derivatives may be used.

The concentration of ethyl esters can be adjusted by, for example, incorporating one or more kinds of ethyl esters and/or one or more kinds of monoterpene derivatives into a saccharide-reduced fruit beverage. That is, the production method of the present invention may comprise a step of adding ethyl esters and/or monoterpene derivatives to a saccharide-reduced fruit beverage.

When incorporating ethyl esters, one or more kinds of desired components as pure products may be incorporated, or a flavoring composition containing the components may be incorporated. When incorporating ethyl esters, the amount of ethyl esters to be added can be determined so that a saccharide-reduced fruit beverage has a desired concentration of ethyl esters in consideration of the concentration of ethyl esters originally contained in the saccharide-reduced fruit beverage. When incorporating monoterpene derivatives, one or more kinds of desired components as pure products may be incorporated, or a flavoring composition containing the components may be incorporated. When incorporating monoterpene derivatives, the amount of monoterpene derivatives to be added can be determined so that a saccharide-reduced fruit beverage has a desired concentration of monoterpene derivatives in consideration of the concentration of monoterpene derivatives originally contained in the saccharide-reduced fruit beverage.

Either straight materials or concentrates may be used as raw materials used in the production method of the present invention. In a case where the concentration of a desired beverage is low, a diluted fruit juice mixed with water or other drinkable liquids can be used as a raw material. In addition, the raw materials used in the production method of the present invention may be used as a mixed juice of two or more kinds of fruit juices.

In the production method of the present invention, process other than the saccharide reduction treatment and the adjustment of the concentration of aroma components described above can be carried out according to a well-known production procedure for fruit beverages. That is, a squeezing step can be carried out before a saccharide reduction treatment to prepare a fruit juice. In a case of using a commercially available concentrate or paste as a raw material, the squeezing step can be omitted. In addition, in a mixing step, other raw materials such as additives can be mixed with a fruit juice which has been subjected to a saccharide reduction treatment. The concentration of aroma components may be adjusted in the mixing step or may be adjusted before or after the mixing step. The mixed liquid obtained in the mixing step can be packed in a container through a sterilization step and a filling step. Beverages of the present invention packed in containers can be subjected to a sealing step and a cooling step as necessary.

According to another aspect of the present invention, there is provided a method for improving a flavor of a saccharide-reduced fruit beverage and a method for improving an insufficient voluminous feeling of the beverage, the methods including adjusting the ethyl ester concentration and/or the monoterpene derivative concentration of the beverage. The method for improving a flavor and the method for improving an insufficient voluminous feeling can be carried out according to the description of the beverages of the present invention and the method for producing the same.

### Examples

The present invention will be described in more detail based on the following examples, but the present invention is not particularly limited to these examples.

### Measurement of Saccharide Concentration, Saccharide Composition, Total Saccharide Concentration, and Brix

In the following examples, the saccharide concentration (monosaccharides, disaccharides, and fructooligosaccharides) in a sample beverage was analyzed according to an absolute calibration curve method in which high-performance liquid chromatography (HPLC method) was used. Specifically, the measurement was carried out as follows.

A sample solution was diluted with water to prepare a solution containing about 2% of saccharides. Impurities were removed by filtering a centrifuged supernatant, and the filtrate was mixed with acetonitrile to prepare a 50% acetonitrile solution. This was analyzed with HPLC (manufactured by JASCO Corporation) according to the following conditions to calculate the saccharide concentration.

### <HPLC Analysis Conditions>

Column: YMC-Pack Polyamine II (manufactured by YMC America)

Mobile phase: 67% (v/v) Acetonitrile solution

Column temperature: 30° C.

Flow rate: 1.0 mL/minute

Detection: Differential refractive index detector

The Brix value was measured using a saccharimeter (Rx-5000a manufactured by Atago Co., Ltd.).

### Example 1: Effect of Saccharide Concentration on Flavor of Orange Fruit Juice

### (1) Preparation of Sample Beverages

Orange fruit juice (65° Bx, Cutrale) was diluted to 45° Bx. 100 g of the diluted orange fruit juice was dispensed into a 200 mL beaker. Subsequently, fructosyltransferase (derived from the genus Aspergillus, manufactured by SHINNIHON CHEMICALS Corporation, sometimes simply referred to as “FTase” below) was added thereto so as to have a concentration of 10 U per gram of sucrose. The mixture was sufficiently stirred so as to become uniform and was then allowed to stand at 25° C. for 4 hours to cause an enzymatic reaction. After the completion of the enzymatic reaction, the resultant was diluted to 11° Bx. Then, the diluted resultant was used for filling a steel can and subjected to a heat treatment at 80° C. for 10 minutes to deactivate the enzyme, and a saccharide-reduced beverage was obtained. The adjustment of the saccharide concentration was performed by mixing the saccharide-reduced beverage with a control beverage at an arbitrary ratio to prepare sample beverages (sample numbers 1 to 5) at 11° Bx and having saccharide concentrations shown in Table 2. In addition, ordinary orange fruit juice (11° Bx) having a saccharide concentration of 8.0 g/100 mL (sucrose concentration of 4.1 g/100 mL) was used as the control beverage.

### (2) Measurement of Saccharide Concentration

The saccharide concentrations (monosaccharides, disaccharides, and fructooligosaccharides) of the sample beverages prepared in (1) above were measured. Regarding the saccharide concentrations, the concentrations of fructose, glucose, sucrose, 1-kestose, nystose, and fructofuranosylnystose were measured (hereinafter, the same applies). The total concentration of fructose, glucose, and sucrose was defined as a saccharide concentration, and the total concentration of neokestose, 1-kestose, nystose, and fructofuranosylnystose was defined as a fructooligosaccharide concentration. The sugar contents of the sample beverages after the enzymatic treatment were all 11° Bx.

### (3) Sensory Evaluation

The sample beverages (sample numbers 1 to 5) prepared in (1) above were used for sensory evaluation. Specifically, relative evaluation (maximum of 5 points) of the sample beverages was performed for a “voluminous feeling” with the score of the ordinary orange fruit juice (control beverage) as 5. Here, the “voluminous feeling” refers to spread of the entire flavor into the oral cavity from the middle to the latter half of drinking. It was scored 5 in a case where there is no difference in the voluminous feeling between a sample beverage and the control beverage, it was scored 4 in a case where a difference can be seen compared to the control beverage, it was scored 3 in a case where a difference can be seen even without comparison with the control beverage, it was scored 2 in a case where the lower limit of the voluminous feeling was observed as orange fruit juice, and it was scored 1 in a case where no voluminous feeling was observed as orange fruit juice. The sensory evaluation was carried out by 4 trained panelists, and the average score of the 4 panelists was calculated. In addition, as a comprehensive evaluation, an average score of 1.0 or more and less than 2.5 (a level at which the voluminous feeling is unacceptable as orange fruit juice) was determined as C, an average score of 2.5 or more and less than 3.25 (a level at which the voluminous feeling is acceptable as orange fruit juice) was determined as B, and an average score of 3.25 to 5.0 (a level at which the voluminous feeling is comfortable as orange fruit juice) was determined as A.

### (4) Results

The results are as shown in Table 2.

TABLE 2
Saccharide concentrations of saccharide-reduced orange
fruit juices and sensory evaluation results

| Sample number | 1 | 2 | 3 | 4 | 5 |
|---|---|---|---|---|---|
| Saccharide | 5.5 | 6.0 | 6.5 | 7.0 | 7.5 |
| concentration (g/100 | | | | | |
| mL) | | | | | |
| Sucrose concentration | 0.7 | 1.4 | 2.1 | 2.7 | 3.4 |
| (g/100 mL) | | | | | |
| Fructooligosaccharide | 1.5 | 1.2 | 0.9 | 0.6 | 0.3 |
| concentration (g/100 | | | | | |
| mL) | | | | | |
| Score | 1.375 | 2.25 | 2.625 | 3.375 | 4.5 |
| Comprehensive | C | C | B | A | A |
| evaluation | | | | | |

It was confirmed from the results of Table 2 that the voluminous feeling in orange fruit juice (11° Bx) having a saccharide concentration of 6.0 g/100 mL or less (sucrose concentration of 1.4 g/100 mL or less) was reduced compared to orange fruit juice (11° Bx, a saccharide concentration of 8.0 g/100 mL, and a sucrose concentration of 4.1 g/100 mL) which was a control beverage and had a general composition.

### Example 2: Effect (1) of Aroma Components on Flavor of Saccharide-Reduced Orange Fruit Juice

### (1) Preparation of Sample Beverages

Orange fruit juice (11° Bx) having a saccharide concentration of 6.0 g/100 mL (sucrose concentration of 1.4 g/100 mL) was prepared in the same manner as in (1) of Example 1. In addition, the above-described orange fruit juice was diluted to prepare orange fruit juices having 7° Bx (a saccharide concentration of 3.8 g/100 mL and a sucrose concentration of 0.9 g/100 mL) and 9° Bx (a saccharide concentration of 4.9 g/100 mL and a sucrose concentration of 1.1 g/100 mL). Next, aroma components were added to the orange fruit juices at 11° Bx, 9° Bx, and 7° Bx prepared. Specifically, sample beverages (sample numbers 6 to 9) were prepared by adding 0.05 volume % (v/v) of each of a flavoring agent A (Ogawa & Co., Ltd., the same applies hereinafter) containing about 10 ppm of α-terpineol as one main component and a flavoring agent B (Givaudan, the same applies hereinafter) containing about 15 ppm of ethyl hexanoate as one main component in the combinations shown in Table 3. In addition, the orange fruit juice at 11° Bx prepared as described above was diluted to obtain orange fruit juices at 7° Bx and 9° Bx, and sample beverages (sample numbers 10 to 15) were prepared.

### (2) Sensory Evaluation

The sample beverages (sample numbers 6 to 15) prepared in (1) above were used for sensory evaluation. The sensory evaluation was carried out by 4 trained panelists according to the method and the criteria described in (3) of Example 1.

### (3) Results

The results are as shown in Tables 3 and 4.

TABLE 3
Combinations of aroma components in saccharide-reduced
orange fruit juices, and sensory evaluation results

| | | | | |
|---|---|---|---|---|
| Sample number | 6 | 7 | 8 | 9 |

| | | | | | |
|---|---|---|---|---|---|
| α-Terpineol | Flavoring | − | − | + | + |
| | agent A | | | | |
| Ethyl | Flavoring | − | + | − | + |
| hexanoate | agent B | | | | |

| | | | | |
|---|---|---|---|---|
| Sensory evaluation | C | B | B | A |

[symbol]

“−” in Table 3 represents no addition of flavoring agents.

TABLE 4
Bx and flavoring agent addition rates of saccharide-reduced
orange fruit juice and sensory evaluation results

| Sample | | | | | | |
|---|---|---|---|---|---|---|
| number | 10 | 11 | 12 | 13 | 14 | 15 |
| Bx | 7° | 9° | 11° | 7° | 9° | 11° |
| Flavoring | 0.06 | 0.08 | 0.1 | 0.1 | 0.1 | 0.1 |
| agent | | | | | | |
| addition rate | | | | | | |
| (volume %) | | | | | | |
| Classification | Flavoring agent addition rate | | | Flavoring agent | | |
| | and Brix being dependent | | | addition rate | | |
| | on each other | | | being fixed | | |
| Sensory | C | B | A | A | A | A |
| evaluation | | | | | | |

It was confirmed from the results of Table 3 that, in the orange fruit juices (11° Bx) obtained by adding either one or a combination of both of the flavoring agent containing ethyl hexanoate and the flavoring agent containing α-terpineol to the orange fruit juice having a saccharide concentration of 6.0 g/100 mL (sucrose concentration of 1.4 g/100 mL), it was possible to compensate for the reduction in the voluminous feeling of the saccharide-reduced orange fruit juices. It was confirmed from the results of Table 4 that, in the orange fruit juices at 7° Bx, 9° Bx, and 11° Bx to which the flavoring agents were added in proportion to the Brix values of the sample beverages, the reduction in the voluminous feeling of the saccharide-reduced orange fruit juices at 7° and 9° Bx was not compensated for. On the other hand, it was confirmed that, in the orange fruit juices obtained by adding 0.05% of the flavoring agents to the above-described orange fruit juices at 7° Bx, 9° Bx, and 11° Bx, it was possible to compensate for the reduction in the voluminous feeling of the saccharide-reduced orange fruit juices regardless of Bx.

### Example 3: Effect (2) of Aroma Components on Flavor of Saccharide-Reduced Orange Fruit Juice

### (1) Preparation of Sample Beverages

Orange fruit juice (11° Bx) having a saccharide concentration of 6.0 g/100 mL (sucrose concentration of 1.4 g/100 mL) was prepared in the same manner as in (1) of Example 1. Next, sample beverages (sample numbers 16 to 36) were prepared by adding the flavoring agent A containing α-terpineol and the flavoring agent B containing ethyl hexanoate to the prepared orange fruit juice so as to have addition rates shown in Table 5.

### (2) Sensory Evaluation

The sample beverages (sample numbers 16 to 36) prepared in (1) above were used for sensory evaluation. The sensory evaluation was carried out by 4 trained panelists according to the method and the criteria described in (3) of Example 1.

### (3) Measurement of Concentrations of Aroma Components

The concentrations (ppb) of components (ethyl butyrate, ethyl hexanoate, linalool, α-terpineol, citral, and geraniol) contributing to the sample beverages prepared in (1) above were measured using GC/MS (device name: GC-2010 Plus, Shimadzu Corporation).

### (4) Results

The results are as shown in Table 5.

TABLE 5
Flavoring agent addition rates and aroma component concentrations of saccharide-
reduced orange fruit juices, and sensory evaluation results

| | | | | |
|---|---|---|---|---|
| Sample number | 16 | 17 | 18 | 19 |

| | |
|---|---|
| Addition rate (volume %) of | 0.01 |
| flavoring agent A | |

| Addition rate (volume %) of | 0.01 | 0.02 | 0.05 | 0.10 |
|---|---|---|---|---|
| flavoring agent B | | | | |
| Concentration (ppb) of ethyl | 8.6 | 13.0 | 22.1 | 39.5 |
| butyrate | | | | |
| Concentration (ppb) of ethyl | 3.8 | 3.6 | 7.3 | 15.9 |
| hexanoate | | | | |
| Total concentration (ppb) of | 12.3 | 16.6 | 29.3 | 55.5 |
| ethyl esters | | | | |
| Concentration (ppb) of linalool | 430.7 | 510.1 | 598.4 | 889.7 |
| Concentration (ppb) of α- | 5.5 | 4.9 | 5.3 | 6.0 |
| terpineol | | | | |
| Concentration (ppb) of citral | 81.9 | 75.6 | 64.2 | 62.9 |
| Concentration (ppb) of geraniol | 20.5 | 19.9 | 22.7 | 25.7 |
| Total concentration (ppb) of | 538.7 | 610.5 | 690.5 | 984.4 |
| Monoterpene derivatives | | | | |
| Comprehensive evaluation | C | B | B | A |
| Sample number | 20 | 21 | 22 | 23 |

| | |
|---|---|
| Addition rate (volume %) of | 0.02 |
| flavoring agent A | |

| | | | | |
|---|---|---|---|---|
| Addition rate (volume %) of | 0.01 | 0.02 | 0.05 | 0.10 |
| flavoring agent B | | | | |
| Concentration (ppb) of | 9.1 | 14.9 | 21.8 | 34.7 |
| ethyl butyrate | | | | |
| Concentration (ppb) of | 2.3 | 3.9 | 6.8 | 13.3 |
| ethyl hexanoate | | | | |
| Total concentration (ppb) of | 11.4 | 18.8 | 28.6 | 47.9 |
| ethyl esters | | | | |
| Concentration (ppb) of linalool | 588.8 | 683.7 | 738.3 | 1053.4 |
| Concentration (ppb) of α- | 6.0 | 6.8 | 5.8 | 7.7 |
| terpineol | | | | |
| Concentration (ppb) of citral | 130.1 | 134.0 | 101.1 | 130.6 |
| Concentration (ppb) of geraniol | 25.6 | 28.7 | 26.7 | 34.9 |
| Total concentration (ppb) of | 750.5 | 853.2 | 872.0 | 1226.5 |
| Monoterpene derivatives | | | | |
| Comprehensive evaluation | B | B | A | A |

| Sample number | 24 | 25 | 26 | 27 | 28 |
|---|---|---|---|---|---|
| Addition rate (volume %) of | 0.05 | | | | |
| flavoring agent A | | | | | |
| Addition rate (volume %) of | 0.01 | 0.02 | 0.05 | 0.10 | 0.15 |
| flavoring agent B | | | | | |
| Concentration (ppb) of ethyl | 17.0 | 20.5 | 25.1 | 32.0 | 44.7 |
| butyrate | | | | | |
| Concentration (ppb) of ethyl | 3.2 | 4.5 | 7.1 | 10.5 | 17.3 |
| hexanoate | | | | | |
| Total concentration (ppb) of | 20.2 | 24.9 | 32.2 | 42.5 | 62.0 |
| ethyl esters | | | | | |
| Concentration (ppb) of linalool | 1159.8 | 1244.4 | 1289.2 | 1476.4 | 1734.7 |
| Concentration (ppb) of α- | 9.9 | 10.2 | 10.1 | 10.4 | 12.4 |
| terpineol | | | | | |
| Concentration (ppb) of citral | 354.5 | 339.3 | 296.1 | 266.6 | 267.2 |
| Concentration (ppb) of geraniol | 46.9 | 51.6 | 48.4 | 46.3 | 59.6 |
| Total concentration (ppb) of | 1571.1 | 1645.6 | 1643.7 | 1799.8 | 2074.0 |
| Monoterpene derivatives | | | | | |
| Comprehensive evaluation | B | B | A | A | B |
| Sample number | 29 | 30 | 31 | 32 | 33 |
| Addition rate (volume %) of | 0.10 | | | | |
| flavoring agent A | | | | | |
| Addition rate (volume %) of | 0.01 | 0.02 | 0.05 | 0.10 | 0.15 |
| flavoring agent B | | | | | |
| Concentration (ppb) of ethyl | 21.0 | 23.4 | 28.7 | 36.5 | 41.1 |
| butyrate | | | | | |
| Concentration (ppb) of ethyl | 3.4 | 4.0 | 6.6 | 12.4 | 15.2 |
| hexanoate | | | | | |
| Total concentration (ppb) of | 24.4 | 27.4 | 35.3 | 48.9 | 56.3 |
| ethyl esters | | | | | |
| Concentration (ppb) of linalool | 1703.3 | 1748.0 | 1942.3 | 2027.4 | 2097.9 |
| Concentration (ppb) of α- | 13.4 | 13.9 | 13.8 | 14.6 | 14.4 |
| terpineol | | | | | |
| Concentration (ppb) of citral | 592.5 | 537.0 | 508.6 | 425.5 | 365.7 |
| Concentration (ppb) of geraniol | 68.0 | 71.1 | 61.6 | 71.9 | 65.6 |
| Total concentration (ppb) of | 2377.3 | 2370.0 | 2526.4 | 2539.4 | 2543.5 |
| Monoterpene derivatives | | | | | |
| Comprehensive evaluation | B | B | A | A | B |

| Sample number | 34 | 35 | 36 |
|---|---|---|---|
| Addition rate (volume %) of | 0.15 | | |
| flavoring agent A | | | |
| Addition rate (volume %) of | 0.05 | 0.10 | 0.15 |
| flavoring agent B | | | |
| Concentration (ppb) of | 33.8 | 38.5 | 36.4 |
| ethyl butyrate | | | |
| Concentration (ppb) of | 8.2 | 9.4 | 14.3 |
| ethyl hexanoate | | | |
| Total concentration (ppb) of | 42.0 | 47.9 | 50.7 |
| ethyl esters | | | |
| Concentration (ppb) of linalool | 2353.8 | 2401.9 | 2552.6 |
| Concentration (ppb) of α- | 16.9 | 18.2 | 18.3 |
| terpineol | | | |
| Concentration (ppb) of citral | 651.6 | 731.3 | 543.0 |
| Concentration (ppb) of geraniol | 78.1 | 90.5 | 87.7 |
| Total concentration (ppb) of | 3100.4 | 3241.8 | 3201.6 |
| Monoterpene derivatives | | | |
| Comprehensive evaluation | B | B | C |

It was confirmed from the results in Table 5 that it was possible to compensate for the reduction in the voluminous feeling of the saccharide-reduced orange fruit juices by adding the flavoring agent A containing linalool, α-terpineol, citral, and geraniol to the orange fruit juice having a saccharide concentration of 6.0 g/100 mL (11° Bx, a sucrose concentration of 1.4 g/100 mL) at an addition rate of 0.02 to 0.10 volume % and adding the flavoring agent B containing ethyl hexanoate thereto at an addition rate of 0.05 to 0.10 volume %, that is, through either or a combination of both of setting the total concentration of ethyl esters to 25 to 50 ppb and setting the total concentration of monoterpene derivatives to 600 to 3,000 ppb. It was confirmed from the GC/MS measurement of the flavoring agents that a certain amount of ethyl butyrate and ethyl hexanoate is contained in the flavoring agent A as sub-components and a constant amount of linalool, α-terpineol, citral, and geraniol is contained in the flavoring agent B as sub-components.

### Example 4: Effect (3) of Aroma Components on Flavor of Saccharide-Reduced Orange Fruit Juice

### (1) Preparation of Sample Beverages

Orange fruit juice (11° Bx) having a saccharide concentration of 6.0 g/100 mL (sucrose concentration of 1.4 g/100 mL) was prepared in the same manner as in (1) of Example 1. Subsequently, each pure product of various aroma components was added to the orange fruit juice prepared. Specifically, sample beverages (sample numbers 37 to 48) were prepared by adding α-terpineol and citral as monoterpene derivatives and ethyl hexanoate, ethyl butyrate, and ethyl acetate (all are from FUJIFILM Wako Chemical Corporation) as ethyl esters so as to have addition rates shown in Table 6 in the combinations shown in Table 6.

### (2) Sensory Evaluation

The sample beverages (sample numbers 37 to 48) prepared in (1) above were used for sensory evaluation. The sensory evaluation was carried out by 4 trained panelists according to the method and the criteria described in (3) of Example 1.

### (3) Results

The results are as shown in Table 6.

TABLE 6-1
Addition rates and combinations of aroma components in saccharide-
reduced orange fruit juices, and sensory evaluation results

| Sample number | | 37 | 38 | 39 | 40 | 41 | 42 |
|---|---|---|---|---|---|---|---|
| Monoterpene | α-Terpineol addition | — | 500 | — | — | — | — |
| derivatives | rate (ppb) | | | | | | |
| | Citral addition rate | — | — | 500 | — | — | — |
| | (ppb) | | | | | | |
| Ethyl esters | Ethyl hexanoate | — | — | — | 25 | — | — |
| | addition rate (ppb) | | | | | | |
| | Ethyl butyrate addition | — | — | — | — | 25 | — |
| | rate (ppb) | | | | | | |
| | Ethyl acetate addition | — | — | — | — | — | 25 |
| | rate (ppb) | | | | | | |

| | | | | | | |
|---|---|---|---|---|---|---|
| Score | 2.0 | 2.5 | 2.5 | 3.0 | 3.0 | 2.5 |
| Comprehensive evaluation | C | B | B | B | B | B |

[symbol]

“—” in Table 6 represents no addition of aroma components.

TABLE 6-2
Addition rates and combinations of aroma components in saccharide-
reduced orange fruit juices, and sensory evaluation results (continued)

| Sample number | | 43 | 44 | 45 | 46 | 47 | 48 |
|---|---|---|---|---|---|---|---|
| Monoterpene | α-Terpineol addition | 500 | 500 | 500 | — | — | — |
| derivatives | rate (ppb) | | | | | | |
| | Citral addition rate | — | — | — | 500 | 500 | 500 |
| | (ppb) | | | | | | |
| Ethyl esters | Ethyl hexanoate | 25 | — | — | 25 | — | — |
| | addition rate (ppb) | | | | | | |
| | Ethyl butyrate | — | 25 | — | — | 25 | — |
| | addition rate (ppb) | | | | | | |
| | Ethyl acetate addition | — | — | 25 | — | — | 25 |
| | rate (ppb) | | | | | | |

| | | | | | | |
|---|---|---|---|---|---|---|
| Score | 4.5 | 4 | 3.5 | 4.5 | 4.5 | 4 |
| Comprehensive evaluation | A | A | A | A | A | A |

[symbol]

“—” in Table 6 represents no addition of aroma components.

It was confirmed from the results of Table 6 that, in the orange fruit juices (11° Bx) obtained by adding either one or a combination of both of a 500 ppb monoterpene derivative (α-terpineol or citral) and a 25 ppb ethyl ester (ethyl hexanoate, ethyl butyrate, or ethyl acetate) to the orange fruit juice having a saccharide concentration of 6.0 g/100 mL (sucrose concentration of 1.4 g/100 mL), it was possible to compensate for the reduction in the voluminous feeling of the saccharide-reduced orange fruit juices. Accordingly, it was shown that the reduction in the voluminous feeling of the saccharide-reduced orange fruit juices was compensated for even when any single component of the monoterpene derivative and the ethyl ester was added. It is estimated from the results of Table 5 (sample number 16) that the total concentration of ethyl esters (total concentration of ethyl hexanoate and ethyl butyrate) of the sample 37 will be 11 ppb or less and the total concentration of monoterpene derivatives (total concentration of α-terpineol, linalool, geraniol, and citral) will be 400 to 500 ppb. Accordingly, the total concentration of ethyl esters in the test section to which a 25 ppb ethyl ester was added is 25 to 36 ppb and the total concentration of monoterpene derivatives in the test section to which a 500 ppb monoterpene derivative was added is 900 to 1,000 ppb.

### Example 5: Effect of Saccharide Concentration on Flavor of Grapefruit Fruit Juice and Unshu Mikan Fruit Juice

### (1) Preparation of Sample Beverages

Sample beverages (sample numbers 49 to 58) having the saccharide concentrations shown in Tables 7 and 8 at 9° Bx were adjusted by performing enzymatic treatment and preparation of saccharide concentration in the same manner as in (1) of Example 1 except that a commercially available grapefruit beverage (9° Bx, Kirin Beverage Company, Limited) and a commercially available Unshu mikan beverage (9° Bx, Ehime Beverage Inc.) were used. In addition, an ordinary commercially available grapefruit beverage (9° Bx) having a saccharide concentration of 7.6 g/100 mL (sucrose concentration of 1.4 g/100 mL) and an ordinary commercially available Unshu mikan beverage (9° Bx) having a saccharide concentration of 9.6 g/100 mL (sucrose concentration of 4.1 g/100 mL) were used as control beverages.

### (2) Measurement of Saccharide Concentration

The measurement of saccharide concentrations of the sample beverages prepared in (1) above was performed in the same manner as in (2) of Example 1. The sugar contents of the sample beverages after the enzymatic treatment were all 9° Bx.

### (3) Sensory Evaluation

The sample beverages (sample numbers 49 to 58) prepared in (1) above were used for sensory evaluation. The sensory evaluation was carried out by 2 trained panelists according to the method and the criteria described in (3) of Example 1 except that the scores of the control beverages prepare in (1) above were set to 5.0.

### (4) Results

The results are as shown in Tables 7 and 8.

TABLE 7
Saccharide concentration of saccharide-reduced grapefruit
fruit juices and sensory evaluation results

| Sample number | 49 | 50 | 51 | 52 | 53 |
|---|---|---|---|---|---|
| Saccharide | 7.19 | 7.28 | 7.37 | 7.47 | 7.56 |
| concentration (g/100 | | | | | |
| mL) | | | | | |
| Sucrose concentration | 0.46 | 0.69 | 0.93 | 1.16 | 1.40 |
| (g/100 mL) | | | | | |
| Fructooligosaccharide | 0.22 | 0.17 | 0.11 | 0.06 | 0 |
| concentration (g/100 | | | | | |
| mL) | | | | | |
| Comprehensive | C | C | B | A | A |
| evaluation | | | | | |

TABLE 8
Saccharide concentration of saccharide-reduced Unshu
mikan fruit juices and sensory evaluation results

| Sample number | 54 | 55 | 56 | 57 | 58 |
|---|---|---|---|---|---|
| Saccharide | 7.54 | 7.66 | 7.85 | 8.90 | 9.60 |
| concentration (g/100 | | | | | |
| mL) | | | | | |
| Sucrose concentration | 0.46 | 0.76 | 1.22 | 2.96 | 4.13 |
| (g/100 mL) | | | | | |
| Fructooligosaccharide | 0.96 | 1.10 | 1.31 | 0.53 | 0 |
| concentration (g/100 | | | | | |
| mL) | | | | | |
| Comprehensive | C | B | A | A | A |
| evaluation | | | | | |

It was confirmed from the results of Table 7 that the voluminous feeling in grapefruit fruit juice (9° Bx) having a saccharide concentration of 7.4 g/100 mL or less (sucrose concentration of 0.9 g/100 mL or less) was reduced compared to grapefruit fruit juice (9° Bx, a saccharide concentration of 7.6 g/100 mL, and a sucrose concentration of 1.4 g/100 mL) which was a control beverage and had a general composition. In addition, it was confirmed from the results of Table 8 that the voluminous feeling in Unshu mikan fruit juice (9° Bx) having a saccharide concentration of 7.7 g/100 mL or less (sucrose concentration of 0.8 g/100 mL or less) was reduced compared to Unshu mikan fruit juice (9° Bx, a saccharide concentration of 9.6 g/100 mL, and a sucrose concentration of 4.1 g/100 mL) which was a control beverage and had a general composition.

### Example 6: Effect of Aroma Components on Flavor of Saccharide-Reduced Orange Fruit Juice

### (1) Preparation of Sample Beverages

In addition, a grapefruit fruit juice (9° Bx) having a saccharide concentration of 7.3 g/100 mL (sucrose concentration of 0.7 g/100 mL) and a Unshu mikan fruit juice (9° Bx) having a saccharide concentration of 7.7 g/100 mL (sucrose concentration of 0.8 g/100 mL) were prepared in the same manner as in (1) of Example 5. Subsequently, aroma components were added to the fruit juices prepared. Specifically, sample beverages (sample numbers 59 to 70) were prepared by adding the flavoring agent A containing α-terpineol and the flavoring agent B containing ethyl hexanoate so as to have addition rates shown in Tables 9 and 10.

### (2) Sensory Evaluation

The sample beverages (sample numbers 59 to 70) prepared in (1) above were used for sensory evaluation. The sensory evaluation was carried out by 2 trained panelists according to the method and the criteria described in (3) of Example 5.

### (3) Results

The results are as shown in Tables 9 and 10.

TABLE 9
Flavoring agent addition rates of saccharide-reduced
grapefruit fruit iuices and sensory evaluation results

| Sample number | 59 | 60 | 61 | 62 | 63 | 64 |
|---|---|---|---|---|---|---|
| Addition rate (%) of | 0.01 | | 0.02 | | 0.05 | |
| flavoring agent A | | | | | | |
| Addition rate (%) of | 0.02 | 0.05 | 0.02 | 0.05 | 0.02 | 0.05 |
| flavoring agent B | | | | | | |
| Comprehensive | C | A | C | A | B | A |
| evaluation | | | | | | |

TABLE 10
Flavoring agent addition rates of saccharide-reduced Unshu
mikan fruit juices and sensory evaluation results

| Sample number | 65 | 66 | 67 | 68 | 69 | 70 |
|---|---|---|---|---|---|---|
| Addition rate (%) of | 0.01 | | 0.02 | | 0.05 | |
| flavoring agent A | | | | | | |
| Addition rate (%) of | 0.02 | 0.05 | 0.02 | 0.05 | 0.02 | 0.05 |
| flavoring agent B | | | | | | |
| Comprehensive | C | B | C | A | B | A |
| evaluation | | | | | | |

It was confirmed from the results in Table 9 that it was possible to compensate for the reduction in the voluminous feeling of the saccharide-reduced grapefruit fruit juices through either or a combination of both of adding the flavoring agent A containing α-terpineol to the grapefruit fruit juice having a saccharide concentration of 7.3 g/100 mL (9° Bx, a sucrose concentration of 0.7 g/100 mL) at an addition rate of 0.02 to 0.05% and adding the flavoring agent B containing ethyl hexanoate thereto at an addition rate of 0.05%. In addition, it was confirmed from the results in Table 10 that it was possible to compensate for the reduction in the voluminous feeling of the saccharide-reduced Unshu mikan fruit juices through either or a combination of both of adding the flavoring agent A containing α-terpineol to the Unshu mikan fruit juice having a saccharide concentration of 7.7 g/100 mL (9° Bx, a sucrose concentration of 0.8 g/100 mL) at an addition rate of 0.02 to 0.05% and adding the flavoring agent B containing ethyl hexanoate thereto at an addition rate of 0.05%.

1. A fruit beverage containing citrus fruit and having a sucrose concentration of 1.4 g/100 mL or less in terms of Brix 11°,
wherein the beverage has an ethyl ester concentration of 25 to 50 ppb and/or a monoterpene derivative concentration of 600 to 3,000 ppb.

2. A fruit beverage containing a saccharide-reduced citrus fruit juice,
wherein the beverage has an ethyl ester concentration of 25 to 50 ppb and/or a monoterpene derivative concentration of 600 to 3,000 ppb.

3. The fruit beverage according to claim 1,
wherein the ethyl esters include one or more selected from the group consisting of ethyl hexanoate, ethyl 3-hydroxyhexanoate, ethyl butyrate, ethyl 2-methylbutyrate, ethyl propionate, ethyl 2-methylpropionate, ethyl acetate, and ethyl tiglate.

4. The fruit beverage according to claim 1,
wherein the monoterpene derivatives include one or more selected from the group consisting of α-terpineol, terpinyl acetate, limonene, γ-terpinene, α-phellandrene, α-pinene, β-pinene, linalool, myrcene, geraniol, and citral.

5. The fruit beverage according to claim 1,
wherein the citrus fruit includes one or more selected from the group consisting of orange, grapefruit, and Unshu mikan.

6. The fruit beverage according to claim 1,
wherein a proportion of the fruit juice in the beverage is 30% or more.

7. A method for producing a fruit beverage containing citrus fruit and having a sucrose concentration of 1.4 g/100 mL or less in terms of Brix 11°, the method comprising:
adjusting an ethyl ester concentration of the beverage to 25 to 50 ppb; and/or adjusting a monoterpene derivative concentration of the beverage to 600 to 3,000 ppb.

8. The production method according to claim 7, further comprising:
a step of reducing an amount of saccharides of the beverage.

9. The production method according to claim 8,
wherein the step of reducing an amount of saccharides is performed by one or more treatments selected from the group consisting of an enzyme treatment, a membrane filtration treatment, a catalyst treatment, and a fermentation treatment.

10. The production method according to claim 7,
wherein the citrus fruit includes one or more selected from the group consisting of orange, grapefruit, and Unshu mikan.

11. A method for improving flavor of a fruit beverage containing citrus fruit and having a sucrose concentration of 1.4 g/100 mL or less in terms of Brix 11°, the method comprising:
adjusting an ethyl ester concentration of the beverage to 25 to 50 ppb; and/or adjusting a monoterpene derivative concentration of the beverage to 600 to 3,000 ppb.
